(19) United States
(12) Patent Application Publication
(10) Pub. No.: US 2018/0312099 A1
(43) Pub. Date: Nov. 1, 2018

(54) HYBRID TONNEAU COVER/WORK SURFACE FOR VEHICLE

(71) Applicant: FORD GLOBAL TECHNOLOGIES, LLC, Dearborn, MI (US)

(72) Inventors: Pattrick Loew, Dearborn, MI (US); Benjamin Yilma, Canton, MI (US)

(21) Appl. No.: 15/497,786

(22) Filed: Apr. 26, 2017

(51) Int. Cl. B60P 3/14; B60J 7/14; B60J 7/10; B60J 7/19; E05D 7/12

(52) U.S. Cl. CPC B60P 3/14; B60J 7/141; E05D 7/121; B60J 7/198; B60J 7/104

(57) ABSTRACT

A tonneau cover for a vehicle cargo area includes a plurality of interfacing or interlocking panels at least one of which includes a plurality of deployable supports. A plurality of removable hinges is provided, adapted to retain the plurality of interfacing or interlocking panels in a folded and/or an unfolded configuration. Adjoining panels of the plurality of interfacing or interlocking panels may define an interlocking joint which may further include a sealing member. Removable hinges defining different spans may be provided. The removable hinges may further include locking elements for retaining an engagement between the removable hinges and the interfacing or interlocking panels in particular orientations.

### TECHNICAL FIELD

This disclosure relates generally to tonneau covers for vehicles such as pickup trucks. The disclosure particularly relates to a tonneau cover that is also configured to serve as a work surface.

### BACKGROUND

Vehicles such as pickup trucks having open cargo areas provide significant convenience in hauling and storing items such as tools and other needed equipment. Often, equipment such as sawhorses and other supports and/or work surfaces such as work tables are often transported to a job site. However, a truck cargo area has limited available cargo space, and such items reduce the amount of cargo-carrying space available for other items.

To solve this and other problems, the present disclosure is directed to a tonneau cover for an open cargo area of a vehicle such as a pickup truck which doubles as a work surface at need.

### SUMMARY

In accordance with the purposes and benefits described herein, in one aspect of the present disclosure a tonneau cover for a vehicle cargo area is provided, comprising a plurality of interfacing or interlocking panels, at least one panel of which comprises a plurality of deployable supports and a plurality of removable hinges adapted to retain the plurality of interfacing or interlocking panels in a folded or vertically stacked configuration and/or an unfolded configuration. In embodiments, at least one panel of the plurality of interfacing or interlocking panels comprises deployable supports having a different length dimension than the deployable supports of other panels of the plurality of interfacing or interlocking panels. The tonneau cover may further be provided with a flexible panel dimensioned and configured to cover a top surface of the plurality of interfacing or interlocking panels when in the unfolded configuration.

In embodiments, adjoining panels of the plurality of interfacing or interlocking panels include edges defining an interlocking joint. The interlocking joint may include an interior sealing member. In embodiments, at least one of the plurality of removable hinges defines a different span from others of the plurality of removable hinges whereby top and bottom panels of the plurality of interfacing or interlocking panels are held in the vertically stacked configuration. In embodiments, at least a pair of the plurality of removable hinges define a different span from others of the plurality of removable hinges.

Each of the plurality of removable hinges may include a locking element whereby the hinge pin cannot be withdrawn from a cooperating tonneau cover panel in a certain orientation. In embodiments, the locking element may comprise at least one hinge arm lug adapted to engage a cooperating slot in one or more cooperating panels of the plurality of interfacing panels when in the unfolded configuration. In embodiments, the locking element may further include a second hinge arm comprising a spring-loaded pin.

In another aspect of the disclosure, a tonneau cover assembly for a vehicle cargo area is provided, comprising a plurality of interlocking panels. At least one panel of the plurality of interlocking panels comprises a plurality of deployable supports. The assembly further includes a plurality of removable hinges adapted to retain the plurality of interlocking panels in a folded or vertically stacked and/or an unfolded configuration and a flexible cover adapted to overlay a top surface of the plurality of interlocking panels when in the unfolded configuration.

In embodiments, adjoining panels of the plurality of interlocking panels include edges defining an interlocking joint. In embodiments, the interlocking joint includes an interior sealing member.

In embodiments, at least a one of the plurality of removable hinges defines a different span from others of the plurality of removable hinges whereby top and bottom panels of the plurality of interlocking panels are held in the vertically stacked configuration. In embodiments, at least a pair of the plurality of removable hinges define a different span from others of the plurality of removable hinges.

Each of the plurality of removable hinges may include a locking element whereby the hinge pin cannot be withdrawn from a cooperating tonneau cover panel in a certain orientation. In embodiments, the locking element may comprise at least one hinge arm lug adapted to engage a cooperating slot in one or more cooperating panels of the plurality of interlocking panels when in the unfolded configuration. In embodiments, the locking element may further include a second hinge arm comprising a spring-loaded pin.

In embodiments, at least one panel of the plurality of interlocking panels comprises deployable supports having a different length dimension than the deployable supports of other panels of the plurality of interlocking panels. In embodiments, the tonneau cover assembly comprises three interlocking panels of which two panels comprise deployable supports having a lesser length dimension compared to the deployable supports of the third panel.

In the following description, there are shown and described embodiments of a hybrid tonneau cover/work surface. As it should be realized, the devices are capable of other, different embodiments and their several details are capable of modification in various, obvious aspects all without departing from the devices and methods as set forth and described in the following claims. Accordingly, the drawings and descriptions should be regarded as illustrative in nature and not as restrictive.

### BRIEF DESCRIPTION OF THE DRAWINGS

The accompanying drawing figures incorporated herein and forming a part of the specification, illustrate several aspects of a hybrid tonneau cover/work surface, and together with the description serve to explain certain principles thereof. In the drawings:

FIG. 1 shows a tonneau cover according to the present disclosure, disposed over a rear cargo area of a vehicle;

FIG. 2 shows a bottom perspective view of the tonneau cover of FIG. 1 in an unfolded configuration, wherein each panel of the tonneau cover includes a plurality of deployable supports and is retained in the depicted unfolded configuration by hinges;

FIG. 3 shows the tonneau cover of FIG. 1, overlayed with a flexible soft cover panel;

FIG. 4 shows the tonneau cover of FIG. 2 in a folded configuration;

FIG. 5A illustrates the tonneau cover of FIG. 1 in the unfolded configuration, including an interlocking interface feature;

FIG. 5B illustrates the tonneau cover of FIG. 5A in a partially folded configuration, showing a sealing member disposed in an interface between adjoining tonneau cover panels;

FIG. 6A shows an embodiment of a hinge for use with the tonneau cover of FIG. 1;

FIG. 6B shows adjoining tonneau cover panels in an unfolded configuration, and including cooperating slotted apertures for receiving the hinge of FIG. 6A;

FIG. 6C shows the adjoining tonneau cover panels of FIG. 6B in an unfolded configuration;

FIG. 7A shows an alternative embodiment of a hinge for use with the tonneau cover of FIG. 1;

FIG. 7B shows adjoining tonneau cover panels in an unfolded configuration, and including cooperating apertures for receiving the hinge of FIG. 7A;

FIG. 7C shows the adjoining tonneau cover panels of FIG. 7B in an unfolded configuration;

FIG. 8A shows a rear view of an embodiment of a hinge arm engaging a cooperating slotted receiver; and

FIG. 8B shows a side view of an alternative embodiment of a hinge arm engaging a cooperating receiver.

Reference will now be made in detail to embodiments of a hybrid tonneau cover/work surface, examples of which are illustrated in the accompanying drawing figures. The figures are not necessarily to scale and some features may be exaggerated or minimized to show details of particular components. The specific structural and functional details disclosed are not to be interpreted as limiting, but as a representative basis for teaching one skilled in the art how to practice the disclosed concepts.

### DETAILED DESCRIPTION

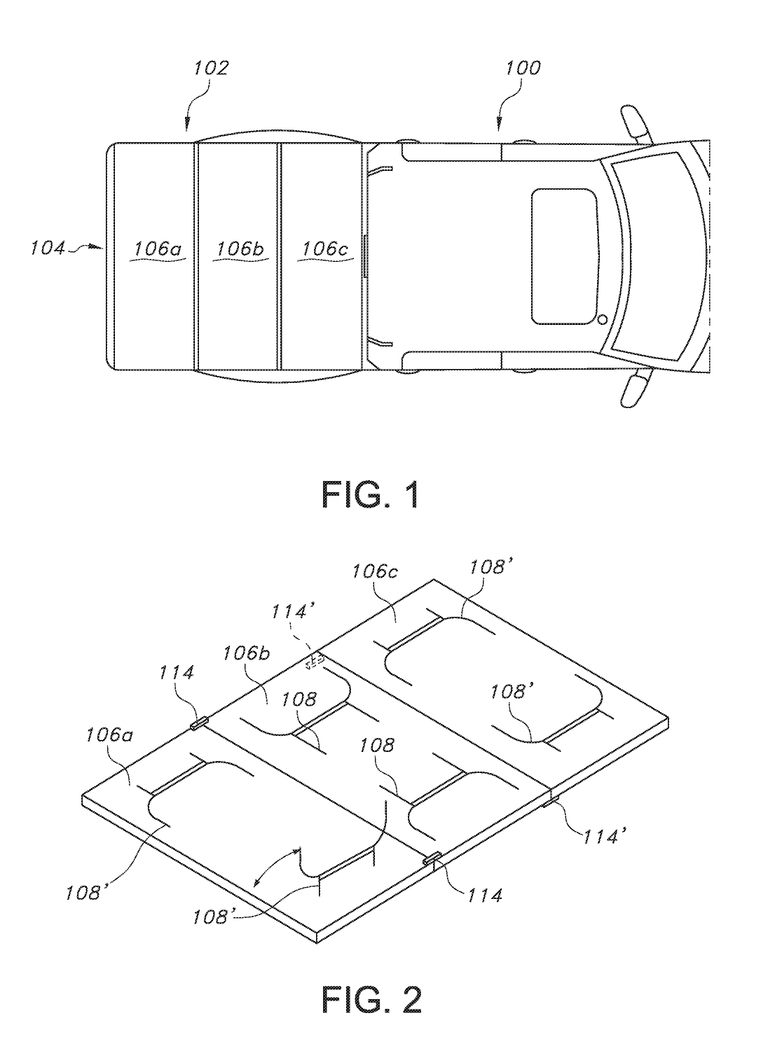

FIG. 1 depicts a vehicle 100, in the depicted embodiment being a pickup truck including a rear open cargo area 102. A tonneau cover assembly 104 is provided, including a tonneau cover 106 defined by a plurality of interfacing panels 106a . . . x configured to overlay and cover the open cargo area 102. In the depicted embodiment, the tonneau cover is defined by three interfacing panels 106a, 106b, 106c. However, it will be readily appreciated that the tonneau cover 106 could be defined by fewer or additional interfacing panels.

With reference to FIG. 2, at least one of the interfacing panels 106a . . . x includes two or more deployable supports 108. The deployable supports 108 are hingedly connected to a bottom surface of the interfacing panels 106a, 106b, 106c in a manner well known in the art, whereby the supports may be translated between a stowed and a deployed position (see arrows). As such, in the deployed position the deployable supports 108 may serve as legs, allowing each interfacing panel 106 having the deployable supports 108 to be used as a free-standing work surface. The deployable supports 108 may be provided as two deployable supports as shown in the drawing, may be provided as four individual deployable supports each disposed substantially at a corner of an interfacing panel 106 (embodiment not shown), or may be provided in other suitable configurations as are well known in the art.

As described above, in an embodiment three interfacing panels 106a, 106b, 106c may be provided to define the tonneau cover assembly 104. In the depicted embodiment, each interfacing panel 106a, 106b, 106c includes a deployable support 108. Further, a one of the three interfacing panels 106b includes a pair of deployable supports 108 having a length dimension that is greater than a length dimension of the deployable supports 108′ carried by the other interfacing panels 106a, 106c. Conveniently, when separated for use this allows the interfacing panels 106a, 106b, 106c to be configured as, respectively, a table and two benches. Of course, alternative embodiments such as interfacing panels 106a, 106b, 106c each having deployable supports of a same length are contemplated. Likewise, providing a tonneau cover assembly 104 including interfacing panels 106a, 106b, 106c of which only one or two include deployable supports 108 of a same or different lengths is contemplated.

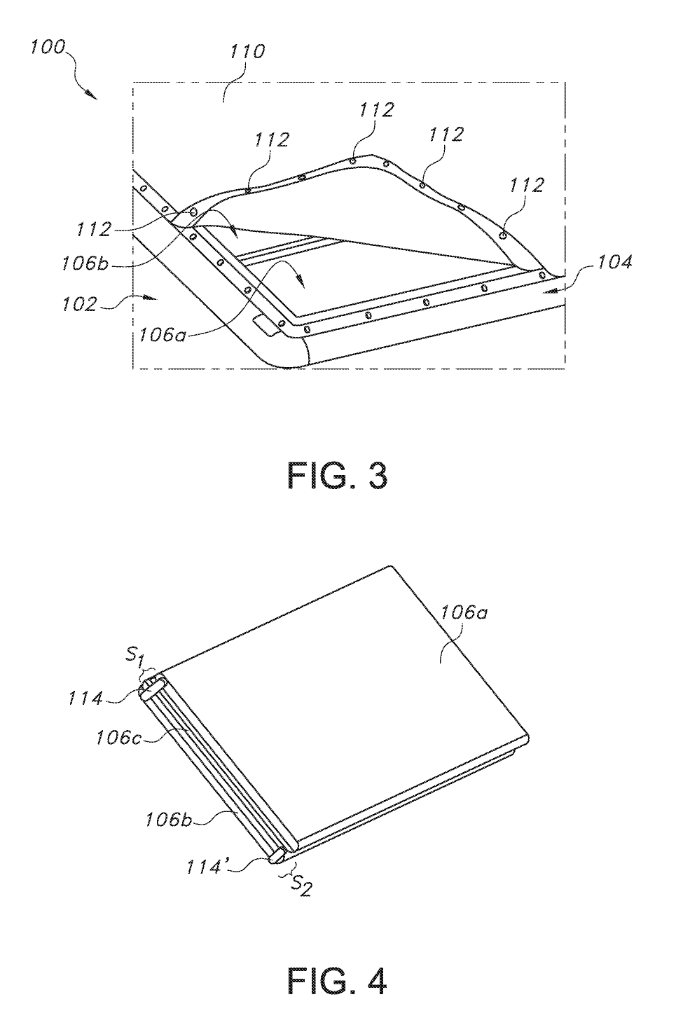

FIG. 3 illustrates a flexible panel covering 110 which may optionally be provided for the tonneau cover assembly 104. Such flexible panel coverings 110 are known in the art, and may be fabricated of a suitable material imparting water-resistance/water-imperviousness to the tonneau cover assembly 104. The flexible panel covering 110 may be secured to the cargo area 102 by any suitable fastener 112, such as the snaps shown in the drawing. However, alternative fasteners are known in the art, including without intending any limitation hook-and-loop fasteners, inserts, buttons, and others, and use of any such suitable fastener is contemplated herein.

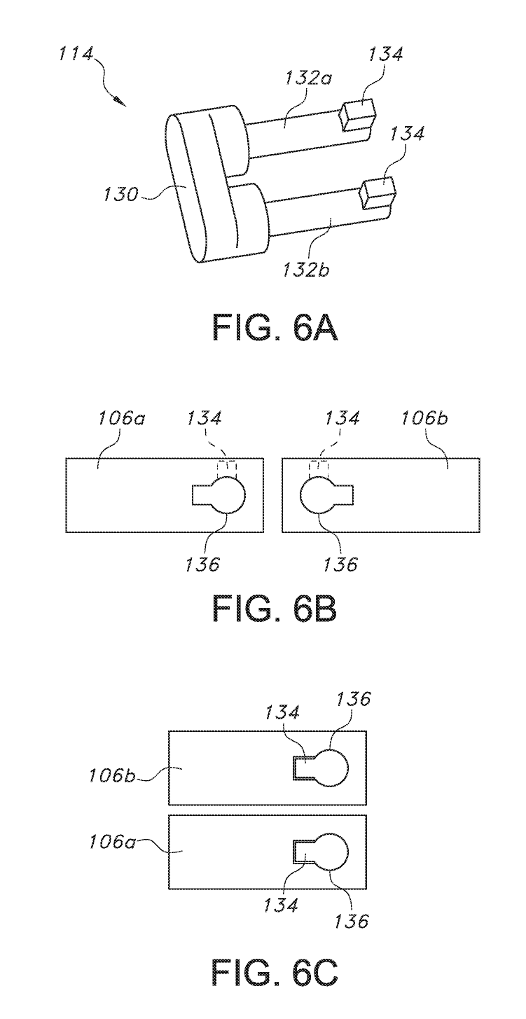

Returning to FIG. 2, the tonneau cover assembly 104 further includes removable hinges 114 adapted to retain the tonneau cover panels 106a, 106b, 106c in the unfolded configuration shown in the drawing and in a folded configuration (not shown in this view). The removable hinges 114 are discussed in greater detail below in the discussion of FIGS. 6A-C and 7A-C.

In an embodiment (see FIG. 4), removable hinges 114 are provided defining a first width or span S1 that is greater than a second width or span S2 defined by other removable hinges 114′. This allows the removable hinges 114, 114′ to retain the tonneau cover panels 106a, 106b, 106c in a folded configuration. As shown in the drawing, removable hinges 114 (only one hinge 114 visible in this view) engage the top-most and bottom-most panels 106a, 106b on one side of the folded tonneau cover assembly 104. Likewise, removable hinges 114′ (only one hinge 114′ visible in this view) engage the intermediate and bottom-most panels 106c, 106b on an opposite side of the folded tonneau cover assembly 104.

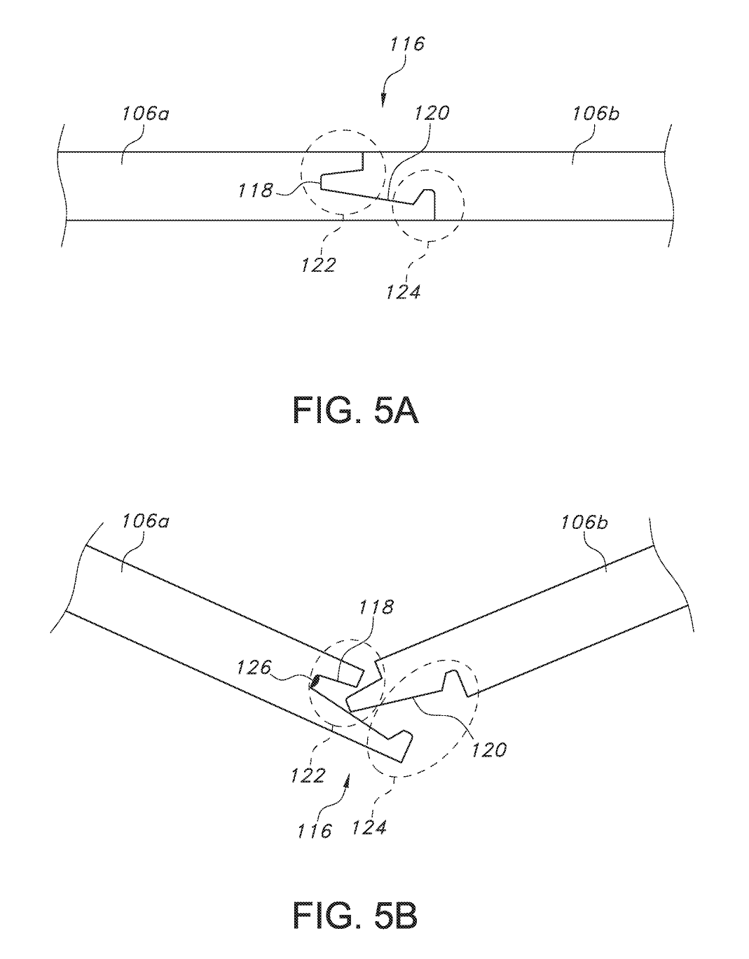

It is contemplated to provide any suitable interface between adjoining tonneau cover panels 106a, 106b, 106c. This could be as simple as adjoining coplanar surfaces or simple tongue and groove structures associated with the edges of adjoining panels 106a, 106b, 106c (embodiments not shown). In the depicted embodiment, an interface is provided between adjoining panels 106a, 106b, 106c which defines an interlocking joint 116 for further stability of the tonneau cover assembly 104 in the unfolded configuration. In one possible embodiment, as shown in FIGS. 5A-B this could be provided by including panels (106a, 106b in the depicted embodiment) having adjoining edges 118, 120 defining a pair of differently oriented tongue and groove joints 122, 124. Optionally, a sealing member 126 (see FIG. 5B) may be disposed in one or both of the grooves of the tongue and groove joints 122, 124 to provide a snug, rattle-free interface between the adjoining panels.

As described above in the discussion of FIGS. 2 and 4, the tonneau cover assembly 104 further may include removable hinges 114, 114′ adapted to retain the tonneau cover panels 106a, 106b, 106c in the folded and unfolded configuration. It is further contemplated to provide locking elements 128 for the removable hinges 114, 114′. In one possible embodiment shown in FIGS. 6A-C, the removable hinges 114 include a cross-piece 130 carrying a pair of arms 132a, 132b. The cross-piece 130 carries the pair of arms 132a, 132b in a spaced-apart, substantially parallel relationship defining a span S1 or S2 as described above.

Each arm 132a, 132b includes a lug 134. Each arm 132a/lug 134 and arm 132b/lug 134 is adapted to engage a cooperating slotted aperture 136 disposed in an edge of a panel 106 (see FIG. 6B), with the arms 132a, 132b having a sufficient length that the associated lugs 134 pass entirely through the slotted portion of each cooperating slotted aperture 136 and into a recess (not shown). When adjoining panels (106a and 106b in the depicted embodiment) are placed in the unfolded configuration shown in FIG. 6B, the lugs 134 are mis-aligned with the slotted portion of the slotted apertures 136, and cannot be withdrawn therefrom. This preserves the aligned configuration needed to use the panels 106 as a tonneau cover assembly 104.

On the other hand, when the adjoining panels 106a, 106b are placed in a folded configuration as shown in FIG. 6C, i.e. in a substantially vertically stacked orientation, the lugs 134 align with the slotted portion of the slotted apertures 136, and can be withdrawn therefrom. As will be appreciated, this allows the panels 106 to be easily separated whereby one or more panels can be used as a work surface as described above.

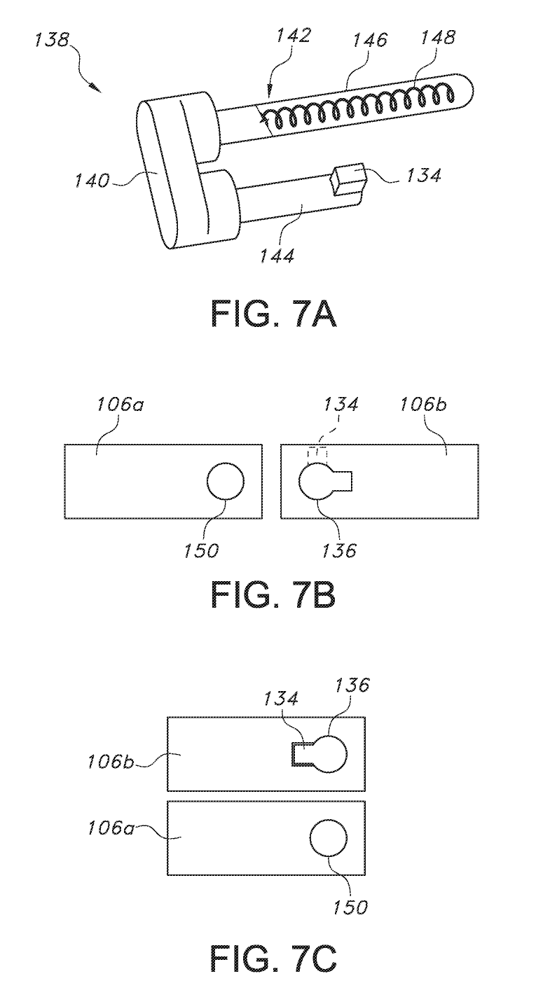

In an alternative embodiment as shown in FIGS. 7A-C, removable hinges 138 are provided including a cross-piece 140 carrying a pair of arms 142, 144. The cross-piece 140 carries the pair of substantially parallel arms 142, 144 in a spaced-apart, substantially parallel orientation defining a span S1 or S2 as described above.

Arm 144 includes a lug 134 as described above. Arm 142 is a compressible arm including a biasable pin 146 including an interior biasing member 148, which may be a coil spring or other suitable biasing member. Arm 144/lug 134 is adapted to engage a cooperating slotted aperture 136 disposed in an edge of a panel (panel 106b in the depicted embodiment, see FIG. 7B), substantially as described and for the purpose described above for arm 132a/lug 134 and arm 132b/lug 134.

Arm 142 is adapted to engage an unslotted aperture 150 disposed in an adjoining panel (panel 106a in the depicted embodiment, see FIG. 7B), with arm 142 having a sufficient length whereby when arm 144 is passed entirely through cooperating slotted aperture 136 as described above for arms 132a/lug 134 and 132b/lug 134, biasing member 148/biasable pin 146 are compressed. As will be readily appreciated, when adjoining panels 106a, 106b are placed in the unfolded configuration shown in FIG. 7B, the lug 134 is mis-aligned with the slotted portion of the slotted aperture 136, and cannot be withdrawn therefrom. Concurrently, the biasable pin 146 urges the hinge 138 outwardly away from the panels 106a, 106b, and concurrently urges the lug 134 against an inner surface of slotted aperture 136 recess. This preserves the aligned configuration needed to use the panels 106 as a tonneau cover assembly 104, and further provides a more secure engagement of the hinge structure 138 to adjoining panels.

In turn, when the adjoining panels 106a, 106b are placed in a folded configuration as shown in FIG. 7C, i.e. in a substantially vertically stacked orientation, the lug 134 aligns with the slotted portion of the slotted aperture 136 for withdrawal therefrom. Concurrently, the biasable pin 146 urges the hinge structure 138 outwardly and away from the adjoining panels 106a, 106b, further enhancing ease and convenience of removal of the removable hinges 138 when the adjoining panels 106 are folded. As will be appreciated, this allows the panels 106a, 106b to be easily separated whereby one or more panels can be used as a work surface as described above.

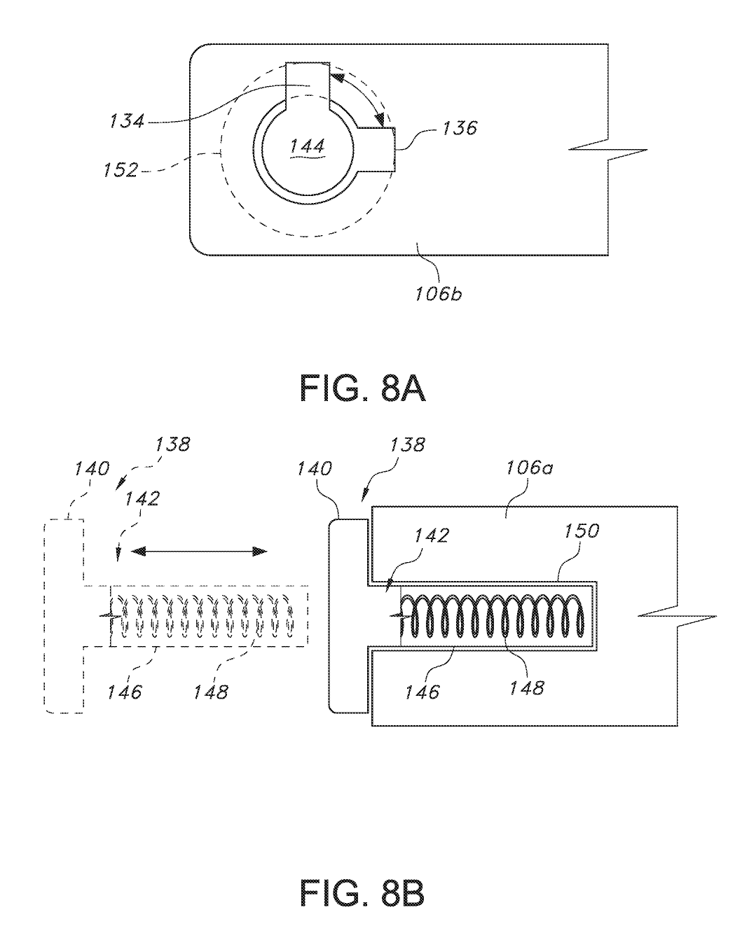

The configurations of the slotted aperture(s) 136 and unslotted aperture 150, and the interaction of arms 142, 144 therewith, are shown in greater detail in FIGS. 8A-8B. FIG. 8A shows a rear view of arm 144, with lug 134 extending beyond a slotted portion of slotted aperture 136 and disposed within a recess 152 located in an interior of the panel 106a. As can be seen from the drawing, translating the panel 106a between a folded and unfolded configuration (see arrow) likewise respectively aligns/misaligns lug 134 with the slotted portion of slotted aperture 136, selectively allowing or preventing withdrawal of the hinge arm 144 from the slotted aperture 136. As will be appreciated, the described interaction of arm 144/lug 134 and slotted aperture 136 applies equally to the interaction of arms 132a/lug 134 and 132b/lug 134 and slotted apertures 136.

FIG. 8B shows a side view of arm 142 interacting with unslotted aperture 150. As shown, fully inserting the hinge 138/arm 142 into aperture 150 (and concomitantly inserting arm 144 into slotted aperture 136 as described above), because of the relative length dimensions of the arm 142 and aperture 150, causes compression of the pin 146/biasing member 148. As described above, when panels 106a, 106b are in the unfolded configuration, the biasing action of biasing member 148 causes lug 134 of arm 144 to press against a surface of recess 152, creating a snug retention. On the other hand, when panels 106a, 106b are translated to the folded/vertically stacked configuration, the lug 134 of arm 144 aligns with the slotted portion of aperture 136, and the biasing action of the biasing member 148 urges the hinge 138 out of apertures 136, 150.

Obvious modifications and variations are possible in light of the above teachings. For example, the tonneau cover 104 may comprise two, three or more adjoining panels 106. All, fewer than all, or only one of the adjoining panels 106 may comprise deployable supports 108. In turn, the panels 106 including deployable supports 108 may include deployable supports of a same or a different length relative to one or more other panels including deployable supports. All such modifications and variations are within the scope of the appended claims when interpreted in accordance with the breadth to which they are fairly, legally and equitably entitled.

What is claimed:

1. A tonneau cover for a vehicle cargo area, comprising:
a plurality of interfacing or interlocking panels, at least one panel of which comprises a plurality of deployable supports; and
a plurality of removable hinges adapted to retain the plurality of interfacing panels in a folded and/or an unfolded configuration.

2. The tonneau cover of claim 1, further including a flexible panel adapted to cover a top surface of the plurality of interfacing or interlocking panels when in the unfolded configuration.

3. The tonneau cover of claim 1, wherein adjoining panels of the plurality of interfacing or interlocking panels include edges defining an interlocking joint.

4. The tonneau cover of claim 3, wherein the interlocking joint includes an interior sealing member.

5. The tonneau cover of claim 1, wherein at least a one of the plurality of removable hinges defines a different span from others of the plurality of removable hinges.

6. The tonneau cover of claim 5, wherein at least a pair of the plurality of removable hinges define a different span from others of the plurality of removable hinges.

7. The tonneau cover of claim 1, wherein each of the plurality of removable hinges includes a locking element.

8. The tonneau cover of claim 7, wherein the locking element comprises at least one hinge arm lug adapted to engage a cooperating slot in one or more cooperating panels of the plurality of interfacing panels when in the unfolded configuration.

9. The tonneau cover of claim 8, wherein the locking element further includes a second hinge arm comprising a spring-loaded pin.

10. The tonneau cover of claim 1, wherein at least one panel of the plurality of interfacing or interlocking panels comprises deployable supports having a different length dimension than the deployable supports of other panels of the plurality of interfacing panels.

11. A tonneau cover assembly for a vehicle cargo area, comprising:
a plurality of interlocking panels, at least one panel of which comprises a plurality of deployable supports;
a plurality of removable hinges adapted to retain the plurality of interlocking panels in a folded and/or an unfolded configuration; and
a flexible panel adapted to cover a top surface of the plurality of interlocking panels when in the unfolded configuration.

12. The tonneau cover assembly of claim 11, wherein adjoining panels of the plurality of interlocking panels include edges defining an interlocking joint.

13. The tonneau cover assembly of claim 12, wherein the interlocking joint includes an interior sealing member.

14. The tonneau cover assembly of claim 11, wherein at least a one of the plurality of removable hinges defines a different span from others of the plurality of removable hinges.

15. The tonneau cover assembly of claim 14, wherein at least a pair of the plurality of removable hinges define a different span from others of the plurality of removable hinges.

16. The tonneau cover assembly of claim 11, wherein each of the plurality of removable hinges includes a locking element.

17. The tonneau cover assembly of claim 16, wherein the locking element comprises at least one hinge arm lug adapted to engage a cooperating slot in one or more cooperating panels of the plurality of interfacing panels when in the unfolded configuration.

18. The tonneau cover assembly of claim 17, wherein the locking element further includes a second hinge arm comprising a spring-loaded pin.

19. The tonneau cover assembly of claim 11, wherein at least one panel of the plurality of interlocking panels comprises deployable supports having a different length dimension than the deployable supports of other panels of the plurality of interlocking panels.

20. The tonneau cover assembly of claim 19, comprising three interlocking panels of which two panels comprise deployable supports having a lesser length dimension than the third panel deployable supports.
